(19) United States
(12) Patent Application Publication
(10) Pub. No.: US 2009/0180657 A1
(43) Pub. Date: Jul. 16, 2009

(54) Personal communication method and apparatus with reduced audio leakage

(75) Inventor: Osman K. Isvan, Aptos, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc. A DELAWARE CORPORATION, Santa Cruz, CA (US)

(21) Appl. No.: 10/455,554

(22) Filed: Jun. 4, 2003

(51) Int. Cl. H04R 1/10

(52) U.S. Cl. 381/371

(57) ABSTRACT

Personal audio method and devices, such as headphones, telephone handsets and headsets, with reduced audio leakage are disclosed. The personal audio device generally comprises a housing having a first portion and a second portion and a transducer disposed in the housing and having a first and second opposing sides. A rear volume is defined between the housing second portion and the transducer second side, and a front volume is defined between the housing first portion and the user's ear. The housing has a front acoustic port acoustically connecting the front volume to ambient air and a rear acoustic port acoustically connecting an otherwise sealed rear volume to ambient air. The front and rear acoustic ports may be configured so that their extent is small, e.g., less than 20 or more preferably 10 times the square root of their total acoustic radiating area. The front and rear acoustic ports may be configured so that their acoustic centers are separated by a small distance, e.g., less than four or more preferably two times the effective diameter of the transducer.

### BACKGROUND OF THE INVENTION

1. Field of the Invention

The present invention relates generally to personal audio devices. More specifically, personal audio method and devices, such as headphones, telephone handsets and headsets, with reduced audio leakage are disclosed.

2. Description of Related Art

In personal communication devices such as telephone handsets and headsets, acoustic coupling between the receiver module (the speaker) and the transmit module (the microphone) results in some of the received signals appearing in the transmit path. Where the transmission delay (latency) is sufficiently long, such acoustic coupling between the speaker and the microphone causes the far-end talker to hear an annoying echo of his/her own voice. Thus, communication devices used in time-delayed networks, such as Voice over Internet Protocol (VoIP), should provide high levels of signal loss between the receive and transmit modules in order to minimize acoustic coupling. Further, for increased privacy of the received communications, it is desirable that for a given sound pressure delivered to the user's ear, the sound power radiated to the ambient air (audio leakage) be minimized.

However, performance parameters such as comfort, sensitivity, frequency response and audio leakage, are affected by the construction of the headphone. Various headphone styles also impose specific design constraints. Conventional headphone designs allow for specific trade-offs among various parameters. Thus, what is desirable is to provide a personal audio device with reduced audio leakage without compromising other performance parameters. In two-way communications headsets, less audio leakage results in greater acoustic isolation.

Headphones and earphones are classified into three general construction types: circum-aural (around the ear), intra-aural (in the ear) and supra-aural (on the ear). Intra-aural and supra-aural headphones may be further divided as acoustically sealed or acoustically open. The choice of headphone construction type and the degree of acoustic seal is a matter of compromise among the various performance parameters such as comfort, sensitivity, frequency response and audio leakage.

Acoustically open intra-aural (ear-bud) headphones provide adequate sound quality and an acceptably small level of audio leakage due to their small size. The ear-bud headphones are the most popular type of headphones for mobile stereo applications and for mobile telephones. However ear-bud headphones do not support the weight of a microphone boom without ear inserts, headband or ear hook. Ear-bud headphones are typically preferred where mobility is a high priority.

Acoustically sealed intra-aural (insert-type) headphones create an acoustic seal at the entrance to the ear canal and deliver the output directly into the ear canal. The insert-type headphones combine good frequency response with low audio leakage. However, many users find the insert-type headphones uncomfortable. As is the case with the ear-bud style headphones, the insert-type headphones also do not support the weight of a microphone boom. Insert-type headphones are typically preferred where sound quality and light weight are high priorities.

Circum-aural (around-the-ear) headphones have large ear cups and soft, acoustically impermeable ear cushions that rest around the user's ear. The around-the-ear headphones typically meet all acoustic requirements but require a headband and are heavy, uncomfortable and obtrusive. The around-the-ear headphones are typically preferred where sound quality is a high priority.

Acoustically sealed supra-aural headphones have acoustically impermeable ear cushions made of, for example, closed-cell foam or a flexible outer skin over a foam core. The ear cushion creates an acoustic seal against the user's ear (pinna). The acoustic output from the front of the speaker is delivered to the entrance of the user's ear canal with minimal acoustic leakage called residual leakage. The sound from the back side of the diaphragm may be contained by an acoustically sealed or port-tuned enclosure. Consequently, the total audio leakage from both sides of the speaker is low and, in communications use, the acoustic isolation between transmit and receive modules is high. However, the high acoustic isolation comes at the expense of compromised frequency response. In particular, the frequency response of electro-acoustic conversion from the input at the transducer terminals to sound pressure at the entrance to the user's ear canal is altered by the occlusion of the ear, which, among other things, affects the motion of the speaker diaphragm. The operating principle of the acoustically sealed supra-aural headphones is similar to the standard telephone handset.

In contrast to the acoustically sealed supra-aural headphones, acoustically open supra-aural headphones have ear cushions made of an acoustically permeable material such as open cell foam. The rear cavity is not sealed. Acoustically open supra-aural headphones do not alter the frequency response of the motion of the speaker diaphragm. Thus, when a well-designed speaker is used, a high sound quality is delivered to the user. However, one disadvantage of the open design is that they do not attenuate the ambient noise surrounding the user. A second disadvantage is that audio leakage from both sides of the speaker is high, and consequently, in communications use, the acoustic isolation between transmit and receive modules is low. The acoustically open supra-aural headset is preferred where sound quality is a high priority.

As noted above, in the design of communications headsets, the choice of headphone style and the degree of acoustic seal is a matter of compromise among the various performance parameters such as comfort, sensitivity, frequency response and audio leakage. For example, the supra-aural style may be selected where user comfort is a high priority. Acoustically sealed type supra-aural headphones may be selected for both user comfort and high acoustic isolation typical of intra-aural and circum-aural headphones. Acoustically open type supra-aural headphones may be selected for both user comfort and the preferred sound quality typical of intra-aural and circum-aural headphones.

Another example of a compromise among the various performance parameters is a semi-open supra-aural headset for use in two-way communications. The semi-open supra-aural headset uses, for example, reticulated foam cushions of partial acoustic permeability to partially meet the greater need for high acoustic isolation at the expense of sound quality. The partial acoustic seal against the user's ear (pinna or cavum concha) causes frequency response anomalies that can generally be reduced by designing the acoustic cavities directly in front and behind the speaker with strategically optimized openings that form damped acoustic resonances. Such design modifies the motion of the speaker diaphragm relative to the input signal in a manner that is compensatory to the anomalies in the transfer function of a partly sealed ear cavity. Alternately, the input signal can be electronically equalized. However, although these designs may appear to be adequate on subjective evaluations or testing on standardized artificial ears, they may not satisfy all users due to person-to-person variances.

Thus it would be desirable to provide improved supra-aural headphones that combine the inherently natural frequency response of acoustically open supra-aural headphones with the inherently low audio leakage of acoustically sealed supra-aural headphones. Ideally, the improved supra-aural headphones can be used in two-way communications headsets to increase acoustic isolation (high echo loss) resulting from low audio leakage and to increase sound quality. The improved supra-aural headphones would preferably have low acoustic source impedance such that the sound pressure at the entrance to the ear canal is reasonably faithful to the input signal regardless of the acoustic seal between the ear cushion and the user's ear.

### SUMMARY OF THE INVENTION

Personal audio method and devices, such as headphones, telephone handsets and headsets, with reduced audio leakage are disclosed. It should be appreciated that the present invention can be implemented in numerous ways, including as a process, an apparatus, a system, a device, or a method. Several inventive embodiments of the present invention are described below.

The personal audio device generally comprises a housing having a first portion and a second portion and a transducer disposed in the housing and having a first and second opposing sides. A rear volume is defined between the housing second portion and the transducer second side, and a front volume is defined between the housing first portion and the user's ear. The housing has a front acoustic port acoustically connecting the front volume to ambient air and a rear acoustic port acoustically connecting an otherwise sealed rear volume to ambient air. The front and rear acoustic ports are configured so as to resemble a dipole as closely as possible or practicable, such as by reducing or minimizing the distance between their acoustic centers and/or by reducing or minimizing the extent of the acoustic source formed by the front and rear ports. For example, the front and rear acoustic ports may be configured so that the extent of the acoustic source formed by the front and rear acoustic ports is reduced or minimized, for example, to less than 20 times or more preferably to 10 times the square root of their total acoustic radiating area. Alternatively, the front and rear acoustic ports may be configured so that the distance between their acoustic centers is reduced or minimized, for example, to less than 4 times or more preferably to 2 times the effective diameter of the transducer.

Each port may include one or more vents or openings. The front acoustic port may be defined in a flange of the housing. The front acoustic port and the rear acoustic port may be concentric, i.e., their acoustic centers may be co-located. The housing may include a channel extending between the front volume and the front acoustic port for acoustically connecting the front acoustic port and the front volume. The device may also include an acoustically impermeable ear cushion attached to the housing for positioning against the user's ear.

These and other features and advantages of the present invention will be presented in more detail in the following detailed description and the accompanying figures which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a cross-sectional view of a receiver module of a prior art acoustically open supra-aural headphone.

FIG. 2 is a cross-sectional view of a receiver module of a headset according to one illustrative embodiment of the present invention.

FIG. 3 is a cross-sectional view of a receiver module of a headset according to an alternative illustrative embodiment of the present invention.

### DESCRIPTION OF SPECIFIC EMBODIMENTS

Personal audio method and devices, such as headphones, telephone handsets and headsets, with reduced audio leakage are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

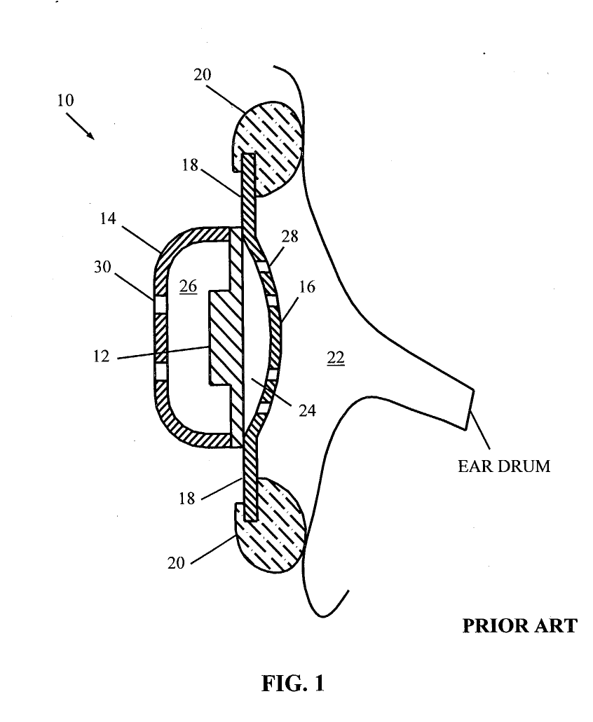

An example of a receiver module (speaker) of a prior art acoustically open supra-aural headphone will be described with reference to FIG. 1 to illustrate the general components of a conventional audio receiver module. Specifically, FIG. 1 is a cross-sectional view of a receiver module 10 of a prior art acoustically open supra-aural headphone. The receiver module 10 includes a transducer or speaker diaphragm 12, a rear enclosure 14, a front face plate 16 having a flange 18, and an acoustically permeable ear cushion 20 attached to the flange 18. The ear cushion 20 is made of an acoustically permeable material such as open cell foam. A front acoustic cavity or volume 22 is formed between the front of the face plate 16 and the user's ear. A middle acoustic cavity 24 is formed between the front of the transducer 12 and the back of the face plate 16. A rear acoustic cavity 26 is formed between the back of the transducer 12 and the rear enclosure 14.

The receiver module 10 provides a controlled acoustic leak from the front of the speaker 12 to the front cavity 22 via a series of vents 28 in the face plate 16. The rear enclosure defines one or more rear acoustic vents 30 acoustically connecting an otherwise sealed rear acoustic cavity 26 behind the transducer 12 with the ambient air. The rear vents 30 form an acoustic source of relatively large dimensions relative to the total area of the rear vents 30. The front and rear acoustic vents 28, 30 provide acoustic leaks between the ambient air and the front and rear acoustic cavities 22, 26, respectively. The acoustically permeable ear cushion 20, which generally conforms to the contours of the pinna, provides a series of irregular gaps between the flange 18 and the user's ear (pinna) to acoustically connect the front cavity 22 to the ambient air.

By providing the front and rear vents 28, 30 and the acoustically permeable ear cushion, the receiver module 10 of the acoustically open supra-aural headphone does not alter the frequency response of the motion of the speaker diaphragm 12 and thereby delivers a high sound quality to the user. However, as noted above, the high sound quality comes at the expense of low attenuation of ambient noise and high audio leakage from both sides of the speaker 12. Specifically, the rear of the transducer 12 is driven out-of-phase relative to the front of the transducer 12 such that the acoustic radiation of the audio leakage from both sides of the receiver module 10 resembles a dipole. However, the geometric extent of the dipole is not small compared to its total radiating area. In particular, due to the relatively large size of the ear (pinna), the acoustic radiation into the ambient air from the front cavity 22, i.e., between the flange 18 and the pinna via the acoustically permeable ear cushion 20, does not approximate a point source. In addition, the rear port 30 of the typical conventional supra-aural headset is also not a point source. Thus, sound emitted from the front and back sides of the receiver module 10 do not sufficiently cancel each other out, i.e., there is high audio leakage from both sides of the receiver module 10. Consequently, in two-way communications use, the acoustic isolation between the receiver module 10 and a transmit module is low.

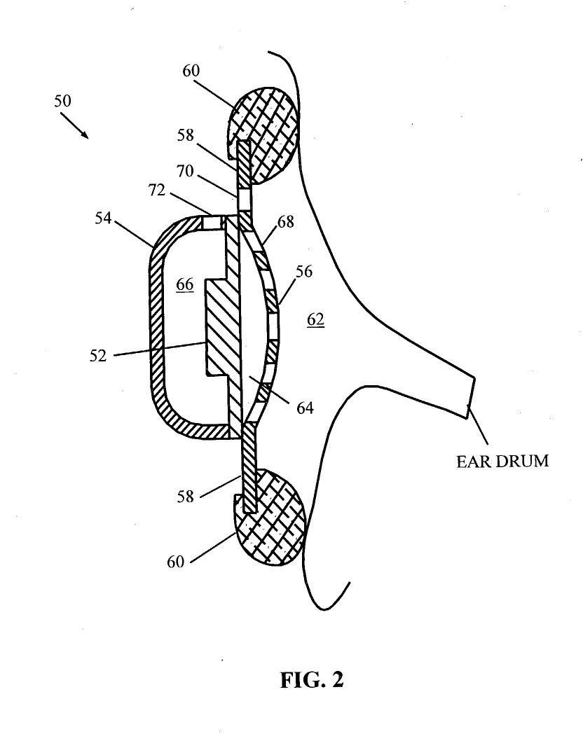

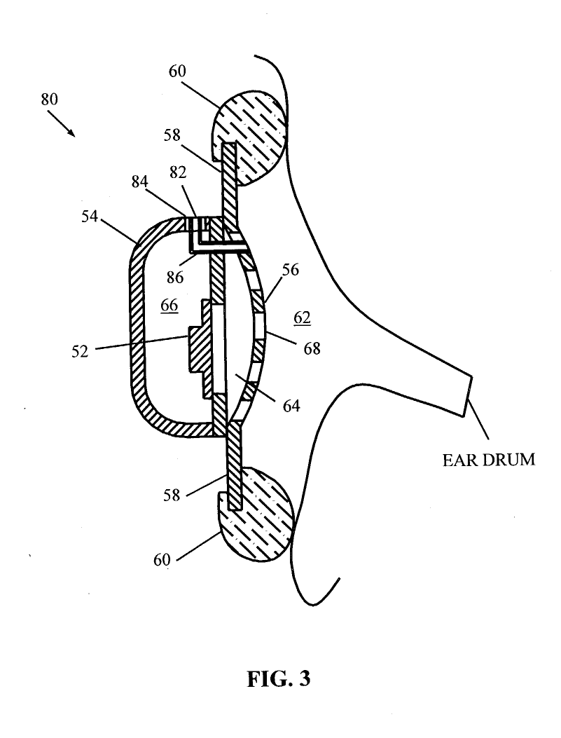

The receiver module of conventional acoustically open supra-aural headphones having been described above with reference to FIG. 1, the improved supra-aural headphones that combine the natural frequency response of acoustically open supra-aural headphones with the low audio leakage of acoustically sealed supra-aural headphones will now be described below with reference to FIGS. 2 and 3.

FIG. 2 is a cross-sectional view of a receiver module 50 of a supra-aural headset according to one illustrative embodiment of the present invention. Although the improved receiver module is described with reference to a supra-aural headset, it is to be understood that the improved receiver module may be utilized in any personal audio device such as an earphone, headphone, handset, and headset.

The receiver module 50 includes a transducer or speaker 52 and a housing including a rear enclosure 54 as its rear portion, a face plate 56 as its front portion. The face plate 56 includes a flange 58 to which an acoustically impermeable ear cushion 60 is attached. The transducer 52 has front and rear opposing sides. The ear cushion 60 is made of an acoustically impermeable material such as closed-cell foam or a flexible outer skin over a foam core. The acoustically impermeable ear cushion generally conforms to the contours of the ear and creates an acoustic seal with the user's ear (pinna) similar to that of conventional sealed supra-aural headphones.

A front acoustic cavity or volume 62 is formed between the front of the face plate 56 and the user's ear. A middle acoustic cavity 64 is formed between the front of the transducer 52 and the back of the face plate 56. A rear acoustic cavity 66 is formed between the back of the transducer 52 and the rear enclosure 54.

A series of vents 68 provided in the face plate 56 acoustically connect the front and the middle cavities 62, 64. In addition, a front port 70 provided in the flange or baffle 58 of the face plate 56 acoustically connect the otherwise sealed front acoustic cavity 62 in front of the face plate 56 with the ambient air. The front port 70 preferably includes a single opening or vent. Alternatively, the front port 70 may include multiple openings or vents preferably positioned closely together such that the geometric extent of the front port 70 is small compared to its total radiating area. The front port 70 provides a first controlled acoustic leak between the front cavity 62 in front of the face plate 56 and the ambient air. A rear port 72 is provided via an opening in the rear enclosure 54 acoustically connecting the otherwise sealed rear acoustic cavity 66 behind the transducer 52 with the ambient air. The rear port 72 preferably includes a single opening or vent. Alternatively, the rear port 72 may include multiple openings or vents preferably positioned closely together such that the geometric extent of the rear port 72 is small compared to its total radiating area. The rear port 72 provides a second controlled acoustic leak between the rear cavity 66 and the ambient air. Preferably, the rear port 72 is disposed in proximity, e.g., adjacent or otherwise as close as practicable, to the front port 70 such that the geometric extent of the dipole sound source formed by the front port 70 and the rear port 72 is small compared to its total radiating area.

The front and rear ports 70, 72 serve as two acoustic sources and are configured such that the acoustic distance therebetween is reduced or minimized. In other words, the two acoustic sources formed by the front and the rear ports 70, 72, which may be damped with the use of acoustic resistance elements therein, are disposed such that the distance between them is relatively small compared to their combined total size. The rear of the transducer 52 is driven out-of-phase with respect to the front of the transducer 52 and the geometric extent of the dipole source formed by the front and rear ports 70 and 72 is small compared to its total radiating area. Thus, the sound emitted from the front port 70 is effectively cancelled by the sound emitted from the rear port 72. Since the ear cushion 60 is acoustically impermeable and generally conforms to the contours of the ear (pinna), no other sound is emitted from the receiver module 50 to the ambient air. Hence, the audio leakage from the receiver module 50 is considerably lower than the audio leakage from the conventional receiver module (such as that shown in and described above with reference to FIG. 1) providing the same acoustic pressure at the ear drum.

According to one preferred embodiment, the extent of the acoustic source formed by both the front and rear ports 70, 72 is less than 20 times, or more preferably less than 10 times, or even more preferably less than 5 times the square root of their total radiating area. According to another preferred embodiment, the acoustic centers of the front and rear ports 70, 72 are separated by an acoustic distance less than four (4) times, or more preferably less than two (2) times, or even more preferably less than the effective diameter of the transducer diaphragm 52. It is noted that although each of the front and rear ports 70, 72 is shown as a single opening, each port 70, 72 may include any suitable number of openings and in any suitable combination of shapes and sizes. It is to be understood that FIG. 2 illustrates merely one example of a suitable configuration of the rear and front ports 70, 72 and any other suitable configuration of front and rear ports may be implemented.

FIG. 3 is a cross-sectional view of a receiver module 80 of a headset according to an illustrative embodiment of the present invention where the acoustic centers of the front and rear ports are co-located. The receiver module 80 shown in FIG. 3 is similar to the receiver module 50 shown in FIG. 2 with the exception of the front and rear ports 82, 84. In particular, the front and rear ports 82, 84 of the receiver module 80 are concentric. Concentricity of the two sound sources 82, 84 can be achieved as an annular gap around a circular opening as shown. As shown, the front port 82 may be provided via a channel or tube 86 extending between the face plate 56 and the rear enclosure 54, acoustically connecting front cavity 62 to the ambient air. Although not shown, the channel extending between the face plate and the rear enclosure may alternatively terminate in a front port that is adjacent to rather than concentric with the rear port.

Concentricity of the front and rear sound sources can be alternatively achieved with the front port as one central hole surrounded by a plurality of peripheral holes serving as rear port. As is evident, any other suitable combination of concentric front and rear sound sources that radiate into the ambient air may be implemented. FIG. 3 illustrates merely one example of providing front and rear ports 82, 84 with collocated or concentric acoustic centers rather than merely being close to each other as is the case in the illustrative embodiment shown in FIG. 2.

The improved receiver module, e.g., receiver module 50 or 80, has low audio leakage, i.e., low amount of acoustic power radiated into the far field, for improved privacy of the received signals. The improved receiver module has low acoustic source impedance such that the headphone is relatively leak-tolerant, i.e., frequency response and sensitivity are relatively independent of headband clamping force or the shape of the user's ear.

In particular, the improved receiver module provides controlled acoustic leak from the front of the speaker to the ambient air, similar to that of conventional open type supra-aural headphones, but the front source is consolidated to approximate a point source. The controlled acoustic leak from the back of the speaker to the ambient air is also consolidated to approximate a point source. In particular, each of the front port and rear port is preferably a single opening but may be multiple openings closely disposed so as to better approximate a point source. The front and rear ports, approximating point sources, are preferably disposed as close to each other as practical. By minimizing the extent of each of the front and rear ports and the distance between the front and rear ports, the dipole formed by the front and rear ports more closely resembles an ideal dipole. Thus, the acoustic power radiated from the front and rear sources to the far field is significantly less than that radiated by each source alone. Hence, audio leakage is reduced as compared to conventional supra-aural headphones without a deterioration of sound quality and frequency response. In two-way communications use, acoustic isolation, i.e., coupling loss between transmit and receive modules, is increased.

In addition to providing low audio leakage typical of acoustically sealed supra-aural headphones, the improved receiver module also provides the natural frequency response typical of acoustically open supra-aural headphones. The improved receiver module provides good sound quality in terms of electro-acoustic sensitivity and frequency response that are equivalent or similar to conventional acoustically open supra-aural headphone such as that shown in and described above with reference to FIG. 1. In addition, the improved receiver module reduces person-to-person variance of electro-acoustic sensitivity and frequency response. Electro-acoustic sensitivity and frequency response are typically measured at the ear drum reference point (DRP) and may be converted to free-field-equivalent values. The free-field-equivalent frequency response achieved with the transducer of the improved receiver module generally does not suffer from anomalies caused by resonances in the front and rear cavities.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

1. A receiver module in a personal audio device for use against a user's ear, comprising:
a housing having a first portion and a second portion;
a transducer disposed in said housing, the transducer having a first and a second opposing side, the housing having a rear volume defined by the housing second portion and the transducer second side, the housing defining a front volume between the housing first portion and the user's ear, the housing further having a front acoustic port acoustically connecting the front volume to ambient air and a rear acoustic port acoustically connecting an otherwise sealed rear volume to ambient air, the front and rear acoustic ports being configured such that the extent of the acoustic source formed by the front and rear acoustic ports is less than 10 times the square root of their total acoustic radiating area so as to reduce audio leakage in the receiver module.

2. The receiver module of claim 1, further comprising an acoustically impermeable ear cushion attached to the housing for positioning against the user's ear.

3. The receiver module of claim 1, wherein the housing includes a flange defining the front acoustic port.

4. The receiver module of claim 1, wherein the front acoustic port and the rear acoustic port are concentric.

5. The receiver module of claim 1, wherein the housing includes a channel extending between the front volume and the front acoustic port for acoustically connecting the front acoustic port and the front volume.

6. The receiver module of claim 1, wherein the rear acoustic port comprises a plurality of openings defined in the housing second portion.

7. The receiver module of claim 1, wherein the front and rear acoustic ports are configured such that the extent of the acoustic source formed by the front and rear acoustic ports is less than 5 times the square root of their total acoustic radiating area.

8. A receiver module in an audio device for use against a user's ear, comprising:
a housing having a first portion and a second portion;
a transducer disposed in said housing, the transducer having a first and a second opposing side, the housing having a rear volume defined by the housing second portion and the transducer second side, the housing defining a front volume between the housing first portion and the user's ear, the housing further having a front acoustic port acoustically connecting the front volume to ambient air and a rear acoustic port acoustically connecting an otherwise sealed rear volume to ambient air, the front and rear acoustic ports being configured such that the acoustic centers of the front and rear ports are separated by an acoustic distance less than two (2) times the effective diameter of the transducer so as to reduce audio leakage in the receiver module.

9. The receiver module of claim 8, further comprising an acoustically impermeable ear cushion attached to the housing for positioning against the user's ear.

10. The receiver module of claim 8, wherein the housing includes a flange defining the front acoustic port.

11. The receiver module of claim 8, wherein the front acoustic port and the rear acoustic port are concentric.

12. The receiver module of claim 8, wherein the housing includes a channel extending between the front volume and the front acoustic port for acoustically connecting the front acoustic port and the front volume.

13. The receiver module of claim 8, wherein the rear acoustic port comprises a plurality of openings defined in the rear enclosure.

14. The receiver module of claim 8, wherein the front and rear acoustic ports are configured such that the acoustic centers of the front and rear ports are separated by a distance less than the effective diameter of the transducer.

15. A receiver module in an audio device for use against a user's ear, comprising:
a housing having a first portion and a second portion; and
a transducer disposed in said housing, the transducer having a first and a second opposing side, the housing having a rear volume defined by the housing second portion and the transducer second side,
the housing defining a front volume between the housing first portion and the user's ear, the housing further having a front acoustic port acoustically connecting the front volume to ambient air and a rear acoustic port acoustically connecting an otherwise sealed rear volume to ambient air, the front acoustic port and the rear acoustic port having co-located acoustic centers so as to reduce audio leakage in the receiver module.

16. The receiver module of claim 15, further comprising an acoustically impermeable ear cushion attached to the housing for positioning against the user's ear.

17. The receiver module of claim 15, wherein the housing includes a channel extending between the front volume and the front acoustic port for acoustically connecting the front acoustic port and the front volume.

18. The receiver module of claim 15, wherein the rear acoustic port comprises a plurality of openings defined in the housing second portion.

19. The receiver module of claim 15, wherein the front and rear acoustic ports are configured such that the extent of the front and rear acoustic ports is less than 10 times the square root of their total acoustic radiating area.

20. A receiver module in an audio device for use against a user's ear, comprising:
a housing having a first portion and a second portion;
a transducer disposed in said housing, the transducer having a first and a second opposing side, the housing having a rear volume defined by the housing second portion and the transducer second side, the housing defining a front volume between the housing first portion and the user's ear, the housing further having a front acoustic port acoustically connecting the front volume to ambient air and a rear acoustic port acoustically connecting an otherwise sealed rear volume to ambient air, the front and rear acoustic ports being configured in a manner selected from the group consisting of the extent of the acoustic source formed by the front and rear acoustic ports is less than 20 times the square root of their total acoustic radiating area and the acoustic centers of the front and rear ports are separated by a distance less than four (4) times the effective diameter of the transducer so as to reduce audio leakage in the receiver module.

21. A receiver module in an audio device for use against a user's ear, comprising:
a housing having a first portion and a second portion;
a transducer disposed in said housing, the transducer having a first and a second opposing side, the housing having a rear volume defined by the housing second portion and the transducer second side, the housing defining a front volume between the housing first portion and the user's ear, the housing further having a front acoustic port acoustically connecting the front volume to ambient air and a rear acoustic port acoustically connecting an otherwise sealed rear volume to ambient air, the rear acoustic port being disposed in proximity to the front acoustic port such that the geometric extent of the acoustic source formed by the front acoustic port and the rear acoustic port is small so as to reduce audio leakage in the receiver module.
